(19) United States
(12) Patent Application Publication
(10) Pub. No.: US 2006/0131072 A1
(43) Pub. Date: Jun. 22, 2006

(54) Conductor support

(76) Inventors: Joseph W. Holland, Boise, ID (US); John M. Bangerter, Boise, ID (US)

Correspondence Address: Joseph W. Holland;HOLLAND & THIEL, P.C., PO Box 1840, Boise, ID, 83701-1840, US

(21) Appl. No.: 10/779,209

(22) Filed: Feb. 13, 2004

(51) Int. Cl. H02G 13/00

(52) U.S. Cl. 174/495

(57) ABSTRACT

A conductor support having a structural attachment member, a flexible connector and a connector retainer engagable with the flexible connector. The structural attachment member includes one or more apertures formed through a cross-section of the structural attachment member. The flexible connector includes a connector body, a retainer engagement element and an insert end configured for insertion through the one or more apertures. The connector retainer is engagable with the flexible connector and includes a connector retaining element, the connector retaining element engagable with the retainer engagement element of the flexible connector to restrict pullout of the flexible connector from the one or more apertures formed through a cross-section of the structural attachment member. In this manner, the conductor is held securely against the support arm.

### FIELD OF THE INVENTION

The present invention relates to a cable or conduit supports generally and more particularly to a cable or conduit support which provides a means for securing one or more cables, conductors or conduits at a selected spacing from an edge of a structural or framing member.

### BACKGROUND OF THE INVENTION

In conventional residential and commercial construction, some or all of the structure may be formed by connecting and erecting various structural or framing member components which may be themselves formed of wood, metal or other materials. Conductors for outlets, switches and fixtures are installed within the framework, often running parallel to the various structural or framing members. Similarly, much of the rough plumbing may be installed within the framework, often running parallel to the various structural or framing members. The trend in plumbing has turned to the use of polymeric conduit such as PEX, (cross-linked polyethylene), for many installations. Following wiring and rough plumbing, panels or other finishing members are secured to the face of the various framing member components covering portions of the electrical and rough plumbing installment.

Since the various structural or framing members are commonly concealed as the panels or other finishing members are being fixed to the structural or framing members, fasteners may, on occasion, miss a structural or framing member and either hit directly or glance against concealed cabling, conduit or other conductors. In doing so the electrical integrity of the cabling or other wiring may be jeopardized. Similarly, while offering various advantages over metal piping, the fact remains that a nail intended to anchor a panel to a framing member, that instead hits a section of a plastic pipe, may pierce or otherwise compromise the ability of the plastic conduit to withstand working pressures. Various building codes take this situation into consideration and may therefore specify that wiring be positioned a defined distance from the nearest edge of a structural or framing member.

The devices available for positioning conductors relative to the location of an edge of a framing or structural member tend to be designed for a single specific conductor, for instance a cable including a pair of insulated wires and a ground. In those instances where for instance a cable including a three insulated wires and a ground, a separate devices may have to be used to accept the larger cable. Similarly, current devices used for positioning electrical conductors relative to the location of an edge of a framing or structural member would not accept a polymeric water conduit, for instance 12 mm PEX. In addition many of the devices currently offered feature an “open” construction, that is cable is placed between a pair of opposing members which hold the cable. It has been observed that cabling placed in such devices may dislodge when subjected to bumping or impact.

Also, it is common in construction to employ the use of metal staples when affixing wiring to structural or framing members. There exists a risk that in making such attachment, a point of a staple may inadvertently pierce the insulating sheath of the conductor, creating a risk of short, failure of a circuit or the conductor itself at the location of the damage to the insulating sheath. Additionally, it is common for building codes to limit or prohibit stacking wiring conductors, one on top of another, under a single staple.

Accordingly, there may be advantage found in providing a device for positioning cables, wiring, conduit or other conductors at a selected distance from an edge of a structural or framing member. Accordingly, advantage may be found in providing a device for positioning cables, wiring or other conductors in a stacked arrangement wherein a set distance is maintained between conductors attached to the support. The device should preferably be low in cost and readily installable utilizing existing tools for mounting and installation. Additionally, advantage may be found in providing a device that permits the attachment of various sizes of wiring, conduit or other conductors on the same support.

It is therefore one object of the present invention to provide a conductor support that provides fast and simple installation at a selected distance from an edge of a structural or framing member, and which permits positioning of cables, wiring or conductors at a selected distance from an edge of a structural or framing member. It is an additional object of the present invention to provide an alternative to the use of staples as a preferred means for attaching conductors to various structural or framing members. Additionally, it is an object of the present invention to provide a conductor support that permits the attachment of more than one conductors in a stacked arrangement without the use of a staple. In addition, it is an object of the present invention to provide a conductor support that permits the attachment of conductors of more than one gage or diameter in a stacked arrangement.

### SUMMARY OF THE INVENTION

The present invention is directed to a conductor support having a conductor support having a structural attachment member, a flexible connector and a connector retainer engagable with the flexible connector. The structural attachment member includes one or more apertures formed through a cross-section of the structural attachment member. The flexible connector includes a connector body, a retainer engagement element and an insert end configured for insertion through the one or more apertures. The connector retainer is engagable with the flexible connector and includes a connector retaining element, the connector retaining element engagable with the retainer engagement element of the flexible connector to restrict pullout of the flexible connector from the one or more apertures formed through a cross-section of the structural attachment member. In this manner, the conductor is held securely against the support arm. In this manner, the conductor is held securely against the support arm. Unless otherwise stated, as used herein, the term “conductor” is intended to include electrical wiring, cabling and conductors of all types as well as conductors of various fluids including piping and tubing for liquids and gasses.

The structural attachment member support arm may be configured to so hold a single conductor or two, three or more conductors in a stacked arrangement using a single flexible connector. In one preferred embodiment, the structural attachment member includes a base element and a support arm connected to and extending from the base element, the support arm including one or more apertures formed through its cross-section and connector retainer is formed integrally to the support arm as a retaining pawl formed within one or more of the apertures in the support. The retainer engagement element may be configured as a plurality of teeth formed along a surface of the connector body for ratcheting engagement with the retaining pawl.

The present invention consists of the device hereinafter more fully described, illustrated in the accompanying drawings and more particularly pointed out in the appended claims, it being understood that changes may be made in the form, size, proportions and minor details of construction without departing from the spirit or sacrificing any of the advantages of the invention.

### DESCRIPTION OF THE DRAWINGS

FIG. 1 is a representative perspective view of a framed wall section wherein a conductor support according to the present invention is shown in use;

FIG. 2 is a representative perspective view of a framed wall section wherein a conductor support according to the present invention is shown in use;

FIG. 3 is a representative perspective view of a conductor support according to the present invention;

FIG. 4 is a representative perspective view of an alternate embodiment of a conductor support according to the present invention;

FIG. 5 is a representative side view of a conductor support according to the present invention;

FIG. 6 is a representative side view of a conductor support according to the present invention;

FIG. 7 is a representative side view cutaway detail of a retainer engagement element and a connector retaining element of a conductor support according to the present invention;

FIG. 8 is a representative side view cutaway detail of a retainer engagement element and a connector retaining element of a conductor support according to the present invention;

FIG. 9 is a representative side view cutaway detail of a retainer engagement element and a connector retaining element of a conductor support according to the present invention;

FIG. 10 is a representative side view cutaway detail of a retainer engagement element and a connector retaining element of a conductor support according to the present invention; and

FIG. 11 is a schematic diagram depicting a method for positioning and securing a conductor relative to a frame member according to the present invention.

### DETAILED DESCRIPTION

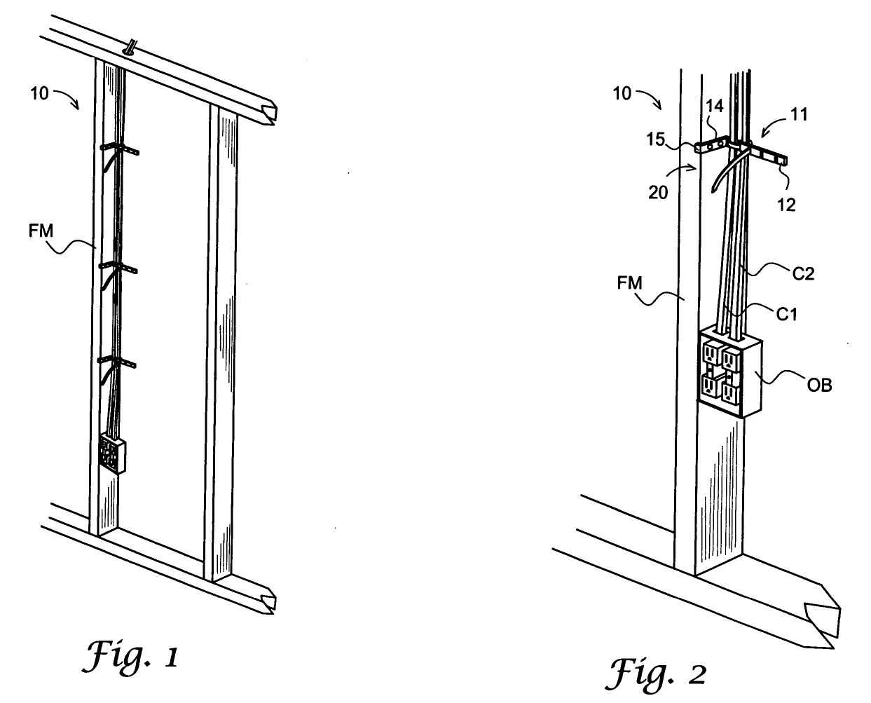

Referring to FIGS. 1 and 2, conductor support 10 is seen in use in an installed position attached to frame member FM. As seen in FIG. 2, conductors C1 and C2 run generally parallel to faming member FM into outlet OB. Conductors C1 and C2 attached conductor support 10 which includes structural attachment member 11 and a flexible connector 20. Structural attachment member 11 includes base element 14 and support arm 12 connected to and extending from base element 14. In the preferred embodiment, base element 14 includes finger 15 connected to and extending from base element 14 with a substantially perpendicular orientation, with finger 15 extending in a direction generally opposite support arm 12.

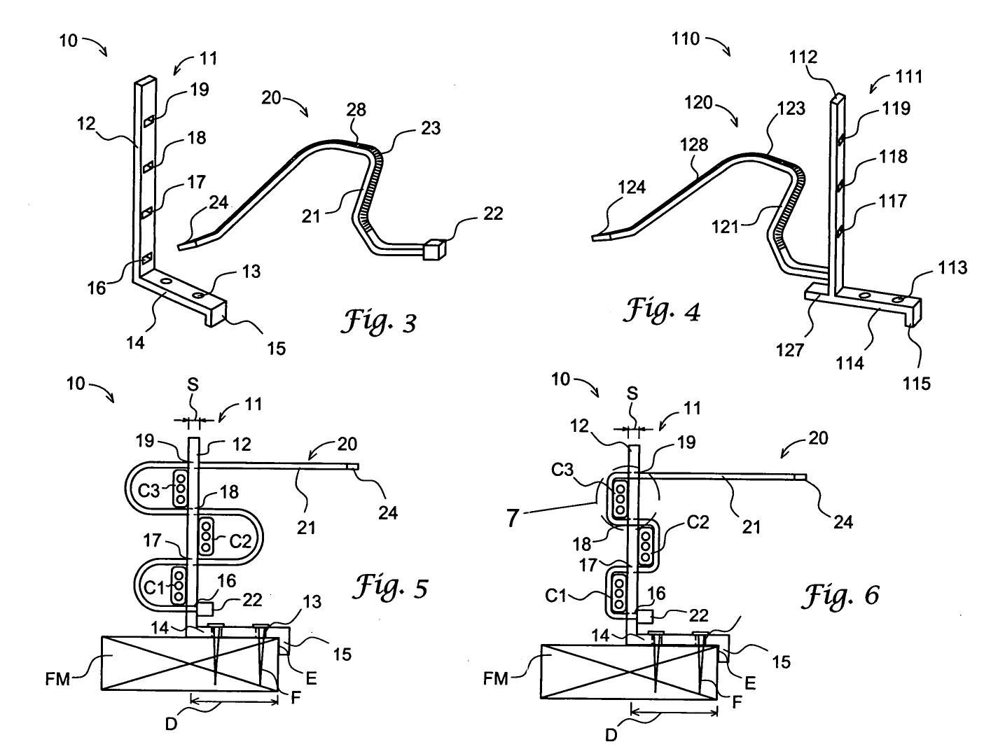

Referring to FIGS. 3, 5 and 6, in one preferred embodiment, conductor support 10 includes structural attachment member 11 and a flexible connector 20. Structural attachment member 11 includes base element 14 and support arm 12 connected to and extending from base element 14. In the preferred embodiment, base element 14 includes finger 15 connected to and extending from base element 14 with a substantially perpendicular orientation, with finger 15 extending in a direction generally opposite support arm 12. Support arm 12 is formed having apertures 16-19 formed through a cross-section S of support arm 12, as seen in FIGS. 5 and 6. Base element 14 includes one or more apertures 13 formed through a cross-section of base element 14, apertures 13 being sized and configured for insertion and passage of a fastener, for instance a nail or screw, (not shown), for attaching structural attachment member 11 to a framing member as seen in FIGS. 1 and 2. In a preferred embodiment, structural attachment member 11 is formed of a resilient material such as plastic, nylon or a high modulus elastomer and can be manufactured through conventional injection molding techniques.

Flexible connector 20 is preferably made of a flexible, resilient material such as plastic, nylon or a high modulus elastomer and can be manufactured through conventional injection molding techniques. As seen in FIGS. 3, 5 and 6, flexible connector 20 includes a connector body 21, an insert end 24 and a head 22 formed at a second end. As seen in FIG. 3, flexible connector 20 further includes a plurality of teeth 23 formed along a first surface 28 of connector body 21. Flexible connector 20 is formed generally in a manner consistent with the manufacture of “cable ties” which are known in the art with the exception that head 22 need not include a retaining pawl for ratcheting engagement with the teeth 23 of flexible connector 20. See for instance U.S. Pat. Nos. 3,484,905, 3,590,442, 3,672,003, 3,761,999 or 4,009,509, all of which are incorporated by reference herein. Referring to FIGS. 3, 5 and 6, insert end 24 is sized and configured for passage through apertures 16-19 of support arm 12. Conductor support 10 has the advantage of utilizing existing cable ties as a flexible connector 20, thereby incorporating a readily available component in the product configuration.

Referring to FIG. 4, an alternate preferred embodiment, conductor support 110 includes structural attachment member 111 and a flexible connector 120. Structural attachment member 111 includes base element 114 and support arm 112 connected to and extending from base element 114. Support arm 112 is formed having apertures 117-119 formed through a cross-section of support arm 112. Base element 114 includes finger 115 connected to and extending from base element 114 with a substantially perpendicular orientation, with finger 115 extending in a direction generally opposite support arm 112. Base element 114 includes one or more apertures 113 formed through a cross-section of base element 114 for insertion and passage of a fastener, for instance a nail or screw, (not shown), for attaching structural attachment member 111 to a framing member as seen in FIGS. 1 and 2. In the embodiment shown in FIG. 4, base element 114 is formed including toe 127, which improves strength at the juncture of base element 114 and support arm 112.

As shown in FIG. 4, flexible connector 120 is an integrally formed structure formed with or affixed to support arm 112. Flexible connector 120 includes a plurality of teeth 123 spaced along a length of a top surface 128 of connector body 121. Insert end 124 is sized and configured for passage through apertures 116-119 of support arm 112.

Referring to FIGS. 5 and 6, flexible connector 20 is shown being employed to position and secure conductors C1-C3 in position relative to frame member FM. Base element 14 is shown positioned on framing member FM and includes apertures 13 formed through a cross-section of base element 14. Apertures 13 are sized and configured for insertion and passage of fasteners F, for attaching structural attachment member 11 to framing member FM. As can be seen, finger 15 extends in a direction generally opposite support arm 12 and indexes against edge E of frame member FM to locate support arm 12 at a set and pre-selected distance D from edge E.

Insert end 24 of flexible connector 20 is passed through aperture 16 from a first side of support arm 12 until head 22 abuts against support arm 12. Flexible connector 20 is then passed over conductor C1 and insert end 24 is inserted through aperture 17 from a second side of support arm 12. Flexible connector 20 is then passed over conductor C2 and insert end 24 is inserted through aperture 18 again from the first side of support arm 12. Flexible connector 20 is then passed over conductor C3 and insert end 24 is inserted through aperture 19 from the second side of support arm 12. Flexible connector 20 may be drawn tight at any stage of the described operation securing and positioning a conductor against support arm 12.

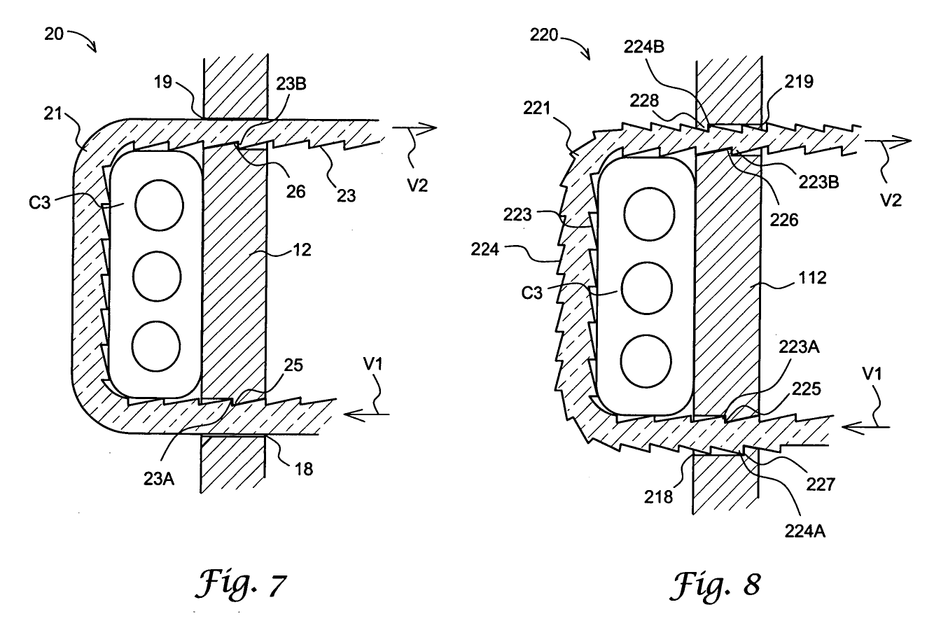

Referring to FIG. 7, a side view cutaway detail, shows support arm 12 including apertures 18 and 19. Conductor C3 is positioned against support arm 12 and is maintained is position by placement of connector body 21 of flexible connector 20 about conductor C3. FIG. 7 shows to advantage the cooperating and engaging arrangement of teeth 23A and 23B with retaining pawls 25 and 26 respectively. As connector body 21 of flexible connector 20 is passed through aperture 18, retaining pawl 25 engages teeth 23 until retaining pawl 25 engages tooth 23A holding tooth 23A in ratcheting engagement thereby providing a resistance to pullout of connector body 21 of flexible connector 20 in the direction indicated generally by the arrow V1. Similarly, flexible connector 20 is passed about conductor C3 and through aperture 12, with retaining pawl 26 engaging teeth 23 until retaining pawl 26 engages tooth 23B holding tooth 23B in ratcheting engagement, thereby pulling conductor C3 securely against support arm 12 and providing a resistance to pullout of flexible connector 20 in the direction indicated generally by the arrow V2.

Referring to FIG. 8, a side view cutaway detail, shows support arm 212 including apertures 218 and 219. Conductor C3 is positioned against support arm 212 and is maintained in position by placement of connector body 221 of flexible connector 220 about conductor C3. FIG. 8 shows connector body 221 of flexible connector 220 including a first side of connector body 221 including teeth 223 and a second side of connector body 221 including teeth 224. FIG. 8 shows to advantage the ratcheting engagement of retaining pawls 225 and 227 with teeth 223A and 224A respectively and the cooperating and the ratcheting engagement of retaining pawls 226 and 227 with teeth 223B and 224B respectively. As connector body 221 of flexible connector 220 is passed through aperture 218, retaining pawl 225 engages teeth 223 until retaining pawl 225 engages tooth 223A holding tooth 223A in ratcheting engagement. Similarly, retaining pawl 227 engages teeth 224 until retaining pawl 227 engages tooth 224A holding tooth 224A in ratcheting engagement. Resistance to pullout of flexible connector 220 in the direction indicated generally by the arrow V1 is thereby accomplished. Similarly, flexible connector 220 is passed about conductor C3 and through aperture 219, with retaining pawl 226 engaging teeth 223 until retaining pawl 226 engages tooth 223B holding tooth 223B in ratcheting engagement. Similarly, retaining pawl 228 engages teeth 224 until retaining pawl 228 engages tooth 224B holding tooth 224B in ratcheting engagement. Resistance to pullout of flexible connector 220 in the direction indicated generally by the arrow V2 is thereby accomplished.

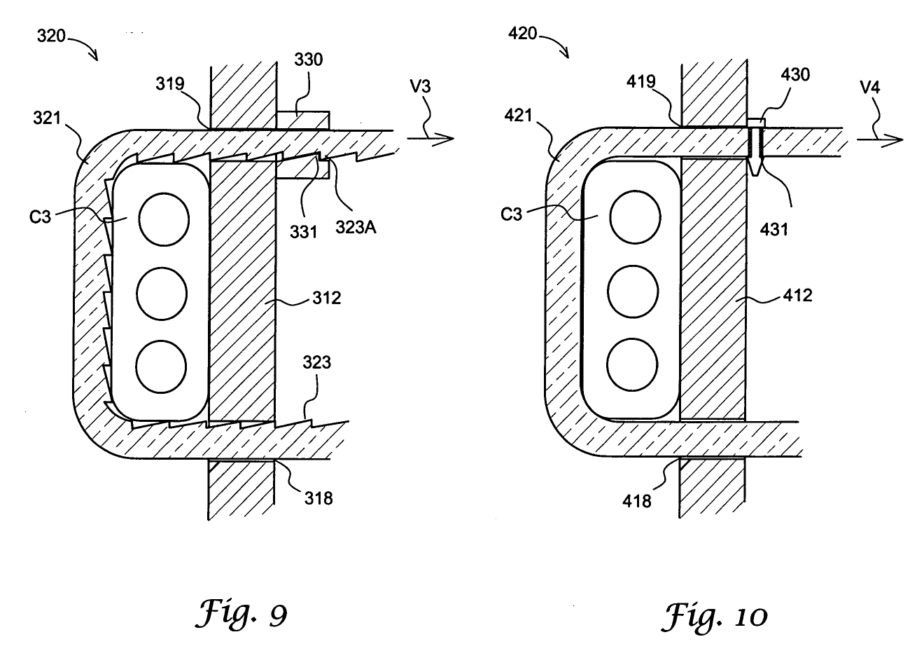

Referring to FIG. 9, a side view cutaway detail, shows support arm 312 including apertures 318 and 319. Conductor C3 is maintained in position by placement of flexible connector 320 about conductor C3. Connector body 321 of flexible connector 320 includes teeth 323. Retaining pawl 331 of nut 330 engages tooth 323A holding tooth 323A in a ratcheting engagement. As connector body 321 is passed through apertures 318 and 319, slack is taken out of flexible connector 320 by pulling tightly on flexible connector 320 to pull conductor C3 securely against support arm 312. Resistance to pullout of flexible connector 320 in the direction indicated generally by the arrow V3 is provided by retaining pawl 331 engaging tooth 323A.

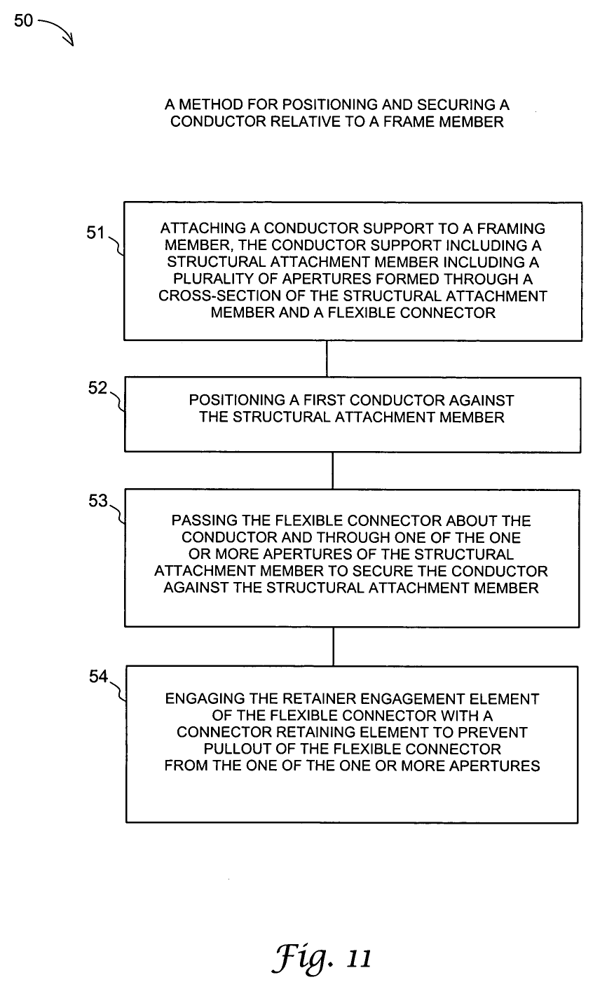

FIG. 10 shows a side view cutaway detail of an alternate embodiment of the invention wherein support arm 412 including apertures 418 and 419. Once again, conductor C3 is maintained in position by placement of flexible connector 420 about conductor C3. In this embodiment, the retainer engagement element includes one or more apertures 430 formed through connector body 421 and the connector retaining element includes pin 431. Slack is taken out of flexible connector 420 by pulling tightly on flexible connector 420 to pull conductor C3 securely against support arm 412. Resistance to pullout of flexible connector 420 in the direction indicated generally by the arrow V4 is provided by pin 431. It will be noted in viewing the Figures, particularly FIGS. 3 through 10, that a conductor attached to and supported by the conductor support of the present invention is held securely to the support arm by the flexible connector and is surrounded completely by the combination of the support arm and the flexible connector. This arrangement provides a support that eliminates the possibility of a conductor being inadvertently displaced from the support. Additionally, while the conductor(s) are securely held in position, they may, if required, be easily detached by cutting the flexible connector. When appropriate, the conductor may be reattached to the support by replacing the flexible connector.

Referring to FIG. 11 A METHOD FOR POSITIONING AND SECURING A CONDUCTOR RELATIVE TO A FRAME MEMBER 50 includes the steps of ATTACHING A CONDUCTOR SUPPORT TO A FRAMING MEMBER, THE CONDUCTOR SUPPORT INCLUDING A STRUCTURAL ATTACHMENT MEMBER INCLUDING A PLURALITY OF APERTURES FORMED THROUGH A CROSS-SECTION OF THE STRUCTURAL ATTACHMENT MEMBER AND A FLEXIBLE CONNECTOR 51, POSITIONING A FIRST CONDUCTOR AGAINST THE STRUCTURAL ATTACHMENT MEMBER 52, PASSING THE FLEXIBLE CONNECTOR ABOUT THE CONDUCTOR AND THROUGH ONE OF THE ONE OR MORE APERTURES OF THE STRUCTURAL ATTACHMENT MEMBER TO SECURE THE CONDUCTOR AGAINST THE STRUCTURAL ATTACHMENT MEMBER 53 and ENGAGING THE RETAINER ENGAGEMENT ELEMENT OF THE FLEXIBLE CONNECTOR WITH A CONNECTOR RETAINING ELEMENT TO PREVENT PULLOUT OF THE FLEXIBLE CONNECTOR FROM THE ONE OF THE ONE OR MORE APERTURES 54.

As the invention has been described, it will be apparent to those skilled in the art that the same may be varied in many ways without departing from the spirit and scope of the invention. Any and all such modifications are intended to be included within the scope of the appended claims. It should be known that the features of flexible connector 20 are not exclusive and could be readily interchanged to create additional embodiments. For example, teeth 23 may have a variety of configurations so long as ratcheting engagement with retaining pawl 25 is achieved. Similarly, attachment member 11 may be configured to accept any number of conductors from one or more for attachment consistent with the teaching of the present invention. Additionally, while structural attachment member 11 is preferably formed of a material such as a plastic or elastomer and can be manufactured through conventional injection molding techniques, it will be appreciated by those skilled in that art that other materials and other manufacturing techniques may be employed to accomplish the objective of the claimed invention.

1. A conductor support comprising:
a base element;
a support arm connected to and extending from the base element, the support arm including one or more apertures formed through a cross-section of the support arm, the support arm including a connector retainer formed in one or more of the one or more apertures formed through the support arm;
a flexible connector including a connector body the flexible connector having a plurality of teeth formed along a surface of connector body, and
wherein the connector retainer sequentially engages the plurality of teeth as the cable connector is inserted through one of the one or more apertures, the connector retainer engaging at least one of the plurality of teeth to restrict pullout of the flexible connector.

2. (canceled)

3. The conductor support of claim 1 wherein the base element further comprises a finger connected to and extending from the base element with an orientation substantially perpendicular to the base element, finger extending in a direction generally opposite support arm.

4. The conductor support of claim 1 wherein the flexible connector further comprises a head formed at a second end of the connector body, the head configured to prohibit passage through the one or more apertures formed through the structural attachment member.

5. The conductor support of claim 1 wherein the flexible connector further comprises the connector body formed integrally to the structural attachment member.

6. The conductor support of claim 1 wherein the flexible connector further comprises the connector body connected to the structural attachment member.

7. The conductor support of claim 1 wherein the connector retaining element further comprises a retaining pawl formed in one or more of the one or more apertures formed through the structural attachment member, and the retainer engagement element comprises a plurality of teeth formed on a first surface of connector body, the retaining pawl engaging of each of the plurality of teeth as the flexible connector is inserted through the at least one of the one or more apertures, the retaining pawl providing a ratcheting engagement against at least one of the plurality of teeth formed on a first surface of connector body.

8. The conductor support of claim 1 further comprising:
a plurality of teeth formed on a second surface of connector body; and
a second retaining pawl formed in one or more of the one or more apertures, the second retaining pawl engaging of each of the plurality of teeth formed on a second surface of connector body as the flexible connector is inserted through the at least one of the one or more apertures, the retaining pawl providing a ratcheting engagement against at least one of the plurality of teeth formed on a second surface of connector body.

9. A conductor support comprising:
a structural attachment member including one or more apertures formed through a cross-section of the structural attachment member;
a flexible connector including a connector body and a plurality of teeth formed along a surface of connector body of flexible connector; and
a retaining pawl formed within at least one of the one or more apertures of the structural attachment member, the retaining pawl sequentially engaging of each of the plurality of teeth formed along a surface of connector body of flexible connector as the flexible connector is inserted through the at least one of the one or more apertures, the retaining pawl adapted to provide a ratcheting engagement against at least one of the plurality of teeth to restrict pullout of the flexible connector.

10. The conductor support of claim 9 wherein the structural attachment member further comprises a base element and a support arm connected to and extending from the base element and the one or more apertures formed through a cross-section of the support arm.

11. The conductor support of claim 10 wherein the base element further comprises a finger connected to and extending from the base element with an orientation substantially perpendicular to the base element, finger extending in a direction generally opposite support arm.

12. The conductor support of claim 9 wherein the flexible connector further comprises a head formed at a second end of the connector body.

13. The conductor support of claim 9 wherein the flexible connector further comprises the connector body formed integrally to the structural attachment member.

14. The conductor support of claim 9 wherein the flexible connector further comprises the connector body connected to the structural attachment member.

15. The conductor support of claim 9 wherein the connector retaining element further comprises a retaining pawl formed in one or more of the one or more apertures formed through the structural attachment member, and the retainer engagement element comprises a plurality of teeth formed on a first surface of connector body, the retaining pawl engaging of each of the plurality of teeth as the flexible connector is inserted through the at least one of the one or more apertures, the retaining pawl providing a ratcheting engagement against at least one of the plurality of teeth formed on a first surface of connector body.

16. The conductor support of claim 13 further comprising:
a plurality of teeth formed on a second surface of connector body; and
a second retaining pawl formed in one or more of the one or more apertures, the second retaining pawl engaging of each of the plurality of teeth formed on a second surface of connector body as the flexible connector is inserted through the at least one of the one or more apertures, the retaining pawl providing a ratcheting engagement against at least one of the plurality of teeth formed on a second surface of connector body.

17. (canceled)
